(19) United States
(12) Patent Application Publication
(10) Pub. No.: US 2025/0360485 A1
(43) Pub. Date: Nov. 27, 2025

(54) Product for Adsorption

(71) Applicant: Active Minerals International, LLC, Sparks, MD (US)

(72) Inventors: Bo Wang, Houston, TX (US); Nestor Alirio CRUZ, Houston, TX (US); Tyler Chanting PULLIG, Houston, TX (US); Lyanne Mylene Anwar, Spring, TX (US); Dennis PARKER, Victor, ID (US)

(73) Assignee: Active Minerals International, LLC, Sparks, MD (US)

(21) Appl. No.: 18/672,361

(22) Filed: May 23, 2024

(51) Int. Cl. B01J 20/18; C02F 1/28; C02F 101/10

(52) U.S. Cl. CPC B01J 20/186; C02F 1/281; C02F 2101/103; C02F 2101/106

(57) ABSTRACT

A product for adsorbing a heavy metal that includes arsenic and/or selenium. The product may comprise clay that has been surface functionalized with a surface treating agent. The surface treating agent may include (a) one or more arsenic affinity functional groups, and/or (b) one or more selenium affinity functional groups. The weight percentage of components of the product may include: 70-99 wt. % clay and 1-30 wt. % surface treating agent. 60-95% of the product is in the form of granules sized to pass through a 10 mesh sieve and to be retained on a 60 mesh sieve, or sized in the range of less than 2000 microns to 250 microns. The clay includes attapulgite and/or sepiolite. Also disclosed is a method of producing the product and a method of adsorbing the heavy metal in a liquid using the product.

### TECHNICAL FIELD

The present disclosure generally relates to products comprising clay that are suitable for the adsorption of arsenic or selenium from liquids.

### BACKGROUND

Elements such as arsenic or selenium are naturally occurring heavy metals. Arsenic, for example, can be found naturally in rocks, and soil and has historically been used in various industrial production processes. Arsenic in, for example, industrial wastewater can act as a contaminate in drinking water, groundwater and bodies of water. Selenium is found in metal sulfide ores, and is used in various commercial products and processes (e.g., pigments, glass making, semiconductors etc.) Similar to arsenic, selenium can act as a contaminate in water.

Metal contaminants, such as arsenic and selenium can be found in oil, liquified natural gas, groundwater and wastewater. Such toxic pollutants in industrial and municipal wastewaters is harmful to human health and the environment.

Common commercially available removal technologies include activated carbon adsorption, sulfur-impregnated activated carbon adsorption, separation by microemulsion liquid membranes, ion exchange and colloid precipitation. The slow kinetics, poor selectivity for these metals and low loading capacity of these technologies make the removal process inefficient and expensive due to the high cost of disposing large volume of waste.

U.S. Pat. No. 8,382,990, issued Feb. 26, 2013, (the '990 patent) describes a process for producing an extruded granular removal media of an onium ion intercalated coupling agent reacted layered bentonite for use in column filtering applications for removing arsenic from gas or water. While the disclosure of the '990 patent may be beneficial, an effective and less expensive removal media is desired that is capable of separating arsenic and selenium from liquids.

### SUMMARY OF THE DISCLOSURE

In one aspect of the present disclosure, a product for adsorbing one or more heavy metals from a liquid is disclosed. The heavy metal may include arsenic and/or selenium. The product may comprise clay that has been surface functionalized with a surface treating agent. The surface treating agent may include (a) one or more arsenic affinity functional groups, and/or (b) one or more selenium affinity functional groups. The weight percentage of components of the product may include: 70-99 wt. % clay and 1-30 wt. % surface treating agent that includes the one or more arsenic affinity functional groups and/or the one or more selenium affinity functional groups. 60-95% of the product is in the form of granules sized to pass through a 10 mesh sieve and to be retained on a 60 mesh sieve, or sized in the range of less than 2000 microns to 250 microns. The clay includes attapulgite and/or sepiolite, wherein, the arsenic affinity functional groups are deposited on the clay surface and/or the selenium affinity functional groups are deposited on the clay surface.

In another aspect of the disclosure, a method of producing a product for adsorbing a heavy metal from a liquid is disclosed. The heavy metal may include arsenic and/or selenium. The method may comprise: surface functionalizing clay with a solution, the solution including a surface treating agent that includes (a) one or more arsenic affinity functional groups, and/or (b) one or more selenium affinity functional groups. Wherein the weight percentage of components of the product includes: 70-99 wt. % clay; and 1-30 wt. % surface treating agent that includes the one or more arsenic affinity functional groups, and/or the one or more selenium affinity functional groups, wherein 60-95% of the product is in the form of granules sized to pass through a 10 mesh sieve and to be retained on a 60 mesh sieve, or sized in the range of less than 2000 microns to 250 microns, wherein the clay includes attapulgite and/or sepiolite, wherein, the arsenic affinity functional groups are deposited on the clay surface and/or the selenium affinity functional groups are deposited on the clay surface,

In yet another aspect of the disclosure, a method for adsorbing at least one heavy metal in a liquid is disclosed. The method may comprise: contacting the liquid with a product, the product comprising clay that has been surface functionalized with a surface treating agent that includes (a) one or more arsenic affinity functional groups, and/or (b) one or more selenium affinity functional groups; and separating the liquid from the product to recover a resultant liquid that has a lower amount of arsenic and/or selenium than the liquid had prior to the contacting, wherein the weight percentage of the components of the product includes: 70-99 wt. % clay, and 1-30 wt. % surface treating agent, wherein 60-95% of the product is in the form of granules sized to pass through a 10 mesh sieve and to be retained on a 60 mesh sieve, or sized in the range of less than 2000 microns to 250 microns, wherein the clay includes attapulgite and/or sepiolite, wherein, the arsenic affinity functional groups are deposited on the clay surface and/or the selenium affinity functional groups are deposited on the clay surface, wherein the product is loaded in the liquid at a weight percentage to have a removal efficiency for arsenic and/or selenium in the liquid of 60-100%.

### BRIEF DESCRIPTION OF THE DRAWINGS

FIG. 1 is a scanning electron microscope (SEM) image of Example 3 at a magnification of ×102;

FIG. 2 is a SEM image of Example 3 at a magnification of ×575;

FIG. 3 is a SEM image of Example 3 at a magnification of ×6001;

FIG. 4 is a SEM image of Example 5 at a magnification of ×100;

FIG. 5 is a SEM image of Example 5 at a magnification of ×343;

FIG. 6 is a SEM image of Example 5 at a magnification of ×7000;

FIG. 7 illustrates the granule size distribution of Examples 2-5;

FIG. 8 is a graph illustrating the percent of arsenic removal at different loadings (grams per liter (g/L)) for Examples 1 and 2;

FIG. 9 is a graph illustrating selenium adsorption for Examples 1 and 2 at different sorbent loadings;

FIG. 10 is a graph illustrating arsenic adsorption for Example 3 at different sorbent loadings;

FIG. 11 is a graph illustrating selenium adsorption for Example 3 at different sorbent loadings; and

FIG. 12 is a graph illustrating the relationship between removal (%) and contact time (minutes (min)) for arsenic and for selenium for the exemplary embodiment of Example 3.

### DETAILED DESCRIPTION

This disclosure relates to products for heavy metal adsorption from liquids. More specifically, the heavy metal adsorbed by the product may include or be selenium and/or arsenic. The products disclosed herein comprise or may be clay. The clay may comprise, or may be: (a) attapulgite, or (b) sepiolite, or (c) attapulgite and sepiolite.

Attapulgite is sometimes referred to as palygorskite. To avoid confusion, as used herein, the term “attapulgite” means attapulgite and/or palygorskite. As is known in the art, attapulgite is a chain crystal lattice type of clay mineral that is structurally different from other clays such as montmorillonite or bentonite. Namely, the tetrahedral sheets of attapulgite are divided into ribbons by inversion because adjacent bands of tetrahedra within one tetrahedral sheet point in opposite directions rather than in one direction thus creating a structure of ribbons of 2:1 layers joined at their edges, and the octahedral sheets are continuous in two dimensions only.

Sepiolite is a hydrated magnesium silicate. The structures of both attapulgite and sepiolite are similar in that tetrahedra pointing in the same direction form 2:1 ribbons that extend in the direction of the a-axis and have an average b-axis width of three linked tetrahedral chains in sepiolite and two linked chains in attapulgite. Attapulgite and sepiolite are structurally different than other clays and do not swell with addition of either water or organic solvents.

In one embodiment, the product may be substantially free of kaolinite or talc.

While activated carbon may be utilized for adsorption of some heavy metals, it is a relatively expensive adsorbent that is not very effective for removal of arsenic. Selenium is known to be very difficult to remove from liquid, and activated carbon is typically ineffective for selenium adsorption as selenium does not respond in the same manner as arsenic. Disclosed herein are novel products that may be used as adsorbents for heavy metals including arsenic and/or selenium in liquid. Such liquid may include, but is not limited to, water (e.g., freshwater, sea water, or the like), oil, liquified natural gas, wastewater or combinations thereof. For example, the liquid may include or may be water in oil, or oil in water.

Such novel product for reducing arsenic and/or selenium in such liquid may comprise clay that has been surface functionalized with a surface treating agent that includes (a) one or more arsenic affinity functional groups, and/or (b) one or more selenium affinity functional groups. The weight percentage of components of the product may include 70-99 wt. % clay and 1-30 wt. % surface treating agent that includes the one or more arsenic affinity functional groups and/or the one or more selenium affinity functional groups. The arsenic affinity functional groups are deposited on the clay surface and/or the selenium affinity functional groups are deposited on the clay surface. The clay may include, or may be, attapulgite and/or sepiolite. In an embodiment, the surface treating agent may comprise or may be: iron chloride, titanium oxide, activated alumina, zirconium oxide, iron oxide, Fe (III) loaded resins, iron oxide, metal oxides, agricultural biomasses, goethite, zerovalent iron, mesoporous alumina, a metal-based nanocomposite, or mixtures thereof.

In an embodiment, about 60% to about 95% of the product may be in the form of granules sized to pass through a 10 mesh sieve and to be retained on a 60 mesh sieve, or sized in the range of less than 2000 microns to 250 microns. In a refinement, about 45% to about 65% of the product may be in the form of granules sized to pass through a 18 mesh sieve and to be retained on a 30 mesh sieve, or granules sized in a range of less than 1000 microns to 595 microns, and about 15% to about 25% of the product may be in the form of granules sized to pass through the 10 mesh sieve and to be retained on the 18 mesh sieve, or granules sized in the range of less than 2000 microns to 1000 microns. In another refinement, about 35% to about 55% of the product may be in the form of granules sized to pass through a 18 mesh sieve and to be retained on a 30 mesh sieve, or granules sized in a range of less than 1000 microns to 595 microns, and about 25% to about 45% of the product may be in the form of granules sized to pass through the 10 mesh sieve and to be retained on the 18 mesh sieve, or granules sized in a range of less than 2000 microns to 1000 microns. In yet another refinement, about 25% to about 35% of the product may be in the form of granules sized to pass through the 18 mesh sieve and to be retained on a 30 mesh sieve, or granules sized in a range of less than 1000 microns to 595 microns, and about 30% to 50% of the product may be in the form of granules sized to pass through the 10 mesh sieve and to be retained on a 18 mesh sieve, or granules sized in a range of less than 2000 microns to 1000 microns. In any one or more of the embodiments/refinements, less than 5% of the product may be in the form of granules and/or particles sized to pass through the 60 mesh sieve, or sized less than 250 microns.

The attapulgite (as feed material) may have a surface area in the range of about 90 m²/g to about 185 m²/g, or about 100 m²/g to about 156 m²/g, or about 100 m²/g to about 150 m²/g as measured using the Brunauer-Emmett-Teller (BET) theory. The sepiolite (as feed material) may have a surface area in the range of about 150 m²/g to about 280 m²/g, or about 245 m²/g to about 280 m²/g, or about 260 m²/g to about 280 m²/g as measured using the Brunauer-Emmett-Teller (BET) theory. The product may have a surface area of about 50 m²/g to about 250 m²/g.

In any one of the embodiments above the attapulgite (as feed material) may have a d₅₀ of about 6 microns to about 25 microns, or about 8 microns to about 22 microns, or about 8 microns to about 19 microns. In any one of the embodiments above the attapulgite (as feed material) may have a particle size distribution having a d₉₀ of about 15 microns to about 80 microns, or about 30 microns to about 70 microns, or about 35 microns to about 65 microns. In any one of the embodiments above the attapulgite (as feed material) may have a particle size distribution having a d₁₀ of about 3 microns to about 8 microns, or about 4 microns to about 7 microns.

In any one of the embodiments above, the sepiolite (as feed material) may have a d₅₀ of about 5 microns to about 20 microns, or about 6 microns to about 18 microns, or about 7 microns to about 17 microns. In any one of the embodiments above the sepiolite (as feed material) may have a particle size distribution having a d₉₀ of about 10 microns to about 40 microns, or about 15 microns to about 30 microns. In any one of the embodiments above the sepiolite (as feed material) may have a particle size distribution having a d₁₀ of about 2 microns to about 8 microns, or about 3 microns to about 7 microns.

In any one of the embodiments above the attapulgite (as feed material) may have a pore volume of about 0.9 milliliter per gram (mL/g) to about 3 mL/g, or about 1 mL/g to about 2 mL/g. In any one of the embodiments above the sepiolite (as feed material) may have a pore volume of about 2 mL/g to about 5 mL/g, or about 2.5 mL/g to about 4 mL/g.

In any one of the embodiments above the attapulgite (as feed material) may have a median pore diameter of about 1 micron to about 5 microns, or about 1 micron to about 4 microns. In any one of the embodiments above the sepiolite (as feed material) may have a median pore diameter of about 1 micron to about 5 microns, or about 2 microns to about 4 microns.

In some embodiments, the attapulgite utilized as feed material may be or may comprise attapulgite that prior to surface functionalization may be free of calcination. In some embodiments, the attapulgite used as feed material may comprise or may be natural attapulgite. In some embodiments, the sepiolite utilized as feed material may be or may comprise sepiolite that prior to surface functionalization may be free of calcination. In some embodiments, the sepiolite used as feed material may comprise or may be natural sepiolite. In some embodiments, but not all embodiments, the clay (e.g., attapulgite, sepiolite) used as feed material may be purified.

In any one of the embodiments above, the product may have an arsenic removal efficiency of 60-100% in the liquid, at a loading of 4-18 grams of the product per liter of the liquid; or the product may have the arsenic removal efficiency of 90-100% in the liquid, at a loading of 6-18 grams of the product per liter of the liquid; or the product may have the arsenic removal efficiency of 95-100% in the liquid, at a loading of 6-18 grams of the product per liter of the liquid; or the product may have the arsenic removal efficiency of 97-100%, at a loading of 6-18 grams of the product per liter of the liquid.

In any one of the embodiments above, the product may have a selenium removal efficiency of 60-100%, at a loading of 1-18 grams of the product per liter of the liquid; or the product may have the selenium removal efficiency of 80-100% in the liquid, at a loading of 1-18 grams of the product per liter of the liquid; or the product may have the selenium removal efficiency of 90-100%, at a loading of 1-18 grams of the product per liter of the liquid; or the product may have the selenium removal efficiency of 95-100% in the liquid, at a loading of 8-20 grams of the product per liter of the liquid.

In any one or more of the embodiments above, the product may further include a binder.

### Preparation of the Product

The method of producing the products discussed above may comprise selecting a clay for processing. The clay may comprise, or may be, (a) attapulgite, or (b) sepiolite, or (c) attapulgite and sepiolite. Attapulgite/palygorskite is a magnesium aluminium phyllosilicate with the chemical formula (Mg,Al)₂Si₄O₁₀(OH)·₄H₂O. Sepiolite is a fibrous hydrated magnesium silicate with the chemical formula Mg₄Si₆O₁₅(OH)₂·6H₂O. The percentages of the various elements may vary depending on the deposit from which the attapulgite or sepiolite is sourced. Both minerals have similar crystal structure with three linked tetrahedral chains in sepiolite and two linked chains in attapulgite.

The bulk chemistry of the attapulgite and/or sepiolite used as feed material impacts the extractable metal properties of the resulting product as such impurities can form extractable metals when the product comes into contact with liquid. Thus, the attapulgite and/or sepiolite may have undergone a purification process to reduce impurities prior to the surface functionalization disclosed herein. Such purification processes are known in the art.

The clay selected may include or may be attapulgite and/or sepiolite. In some embodiments, the attapulgite utilized as feed material may be or may comprise attapulgite that prior to surface functionalization may be free of calcination. In some embodiments, the attapulgite used as feed material may comprise or may be natural attapulgite. In some embodiments, the sepiolite utilized as feed material may be or may comprise sepiolite that prior to surface functionalization may be free of calcination. In some embodiments, the sepiolite used as feed material may comprise or may be natural sepiolite. In some embodiments, but not all embodiments, the clay (e.g., attapulgite, sepiolite) used as feed material may be purified.

Optionally, in some embodiments, the method may further comprise preparing a binder solution that comprises a binder and a liquid. The preparing includes mixing a binder with the liquid until well mixed. The binder solution may be mixed in any suitable vessel, for example a glass beaker, and a magnetic stirrer plate or the like may be utilized, if desired, to facilitate mixing. In one embodiment the binder may comprise or may be colloidal silica. In the embodiments herein, the binder solution is a silica binder solution that comprised colloidal silica and DI water. For example, in Examples 3-5 herein, 2.56 g of LUDOX® AM colloidal silica (MilliporeSigma) was mixed with 10 g of DI water. In other embodiments, other appropriate binders or liquids (e.g., water) may be utilized. If a binder or binder solution is used in the preparation of the product, the method further comprises mixing the binder or the binder solution with the clay until well dispersed and mixed into the clay. In an embodiment, the mixing into the clay may be intermittent instead of continuous, and scraping of the sides of the mixing vessel or stirring may occur between or after intermittent mixing periods.

The method further includes preparing a surface treating solution that comprises a surface treating agent and a liquid. The preparing includes mixing the surface treating agent with the liquid until well mixed to form the surface treating solution. In an embodiment, the surface treating agent may be or may comprise: one or more arsenic affinity functional groups and/or selenium functional groups. In various embodiments discussed herein, the exemplary surface treating solution was prepared by mixing 20-25 grams (g) of a surface treating agent that included an arsenic affinity functional group and/or a selenium affinity functional group (e.g., in the exemplary embodiment, iron chloride (FeCl₃) (MilliporeSigma or Sigma-Alderich)) with 20-25 g water (e.g., DI water) until well mixed (e.g., about 10 minutes). In other embodiments, the surface treating solution may comprise other appropriate amounts of surface treating agent and liquid. The solution may be mixed in any suitable vessel, for example a glass beaker, and a magnetic stirrer plate or the like may be utilized, if desired, to facilitate mixing. The surface treating agent (that includes a arsenic and/or selenium affinity functional group) may comprise or may be: iron chloride, titanium oxide, activated alumina, zirconium oxide, iron oxide, Fe (III) loaded resins, iron oxide, metal oxides, agricultural biomasses, goethite, zerovalent iron, mesoporous alumina, or metal-based nanocomposites, or mixtures thereof. The liquid may be or may comprise water or Deionized (DI) water or the like.

The method further comprises surface functionalizing the clay with the surface treating solution to produce a surface functionalized clay. To facilitate such treatment, the clay may be mixed with the surface treating solution until the solution is well dispersed and mixed into the clay. In some embodiments, the total dosage of surface treating solution may be added at once and mixed into the clay. In other embodiments, the dosage may be divided into appropriate portions and each portion is mixed into the clay before the next portion is mixed into the clay, the process repeated until the entire dosage is utilized.

The method may further comprise reducing the acidity (of the surface functionalized clay) by treating the surface functionalized clay with a neutralizing solution that will bring the pH of the surface functionalized clay to around 7. The neutralizing solution may comprise a base and a liquid. In examples 1-2 herein, about 29.89-37.36 g of a neutralizing solution (NaOH solution (50% concentration) (Lab Alley)) was mixed with the surface functionalized clay until well dispersed. In examples 3-5, about 37.36 g of NaOH solution (50% concentration) (Lab Alley) was diluted with 15 g DI water before being mixed with the surface functionalized clay until well dispersed.

Optionally, in some embodiments, additional liquid (e.g., water, DI water or the like) may be mixed into the surface functionalized clay to facilitate the formation of granules.

The method may further comprise: drying processed clay (e.g., the surface functionalized clay, or surface functionalized and acid reduced clay) to produce the product. In an exemplary embodiment the drying may occur in an oven, or the like, at about 60° C. to about 100° C. for about two to about four hours or until the clay is dried (solution dried on the surface of the clay). The product produced may be substantially granular form. After surface functionalization and drying, the respective affinity groups remain dried on or deposited on the clay surface.

### Adsorption Process

The products disclosed herein may each be used to adsorb arsenic and/or selenium, in a liquid. The liquid may include, but is not limited to, water (e.g., freshwater, sea water, or the like), oil, liquified natural gas, wastewater or combinations thereof. For example, the liquid may include or may be water in oil, or oil in water.

The method may comprise contacting any one or more of the novel products disclosed herein with the liquid. The products disclosed herein may be used as body feed alone and/or precoat mixed with filter aids (such as diatomaceous earth and perlite) in the filtration system. In some embodiments, the liquid and the product may form a slurry (for example, when the product is used as a body feed). The loading of the product that contacts the liquid is that amount of the product sufficient to reduce the amount of arsenic and/or selenium in the liquid in a given contact time such that an arsenic and/or selenium removal efficiency of 60-100%, 80-100%, 90-100%, 95-100% or 97-100% is achieved. In one embodiment, an arsenic removal efficiency of 60-100% in the liquid may be achieved at a loading of 4-18 grams of the product per liter of the liquid; or an arsenic removal efficiency of 90-100% in the liquid may be achieved at a loading of 6-18 grams of the product per liter of the liquid; or an arsenic removal efficiency of 95-100% in the liquid may be achieved at a loading of 6-18 grams of the product per liter of the liquid; or an arsenic removal efficiency of 97-100% in the liquid may be achieved at a loading of 6-18 grams of the product per liter of the liquid. In an embodiment, a selenium removal efficiency of 60-100% in the liquid may be achieved at a loading of 1-18 grams of the product per liter of the liquid; or a selenium removal efficiency of 80-100% in the liquid may be achieved at a loading of 1-18 grams of the product per liter of the liquid; or a selenium removal efficiency of 90-100% in the liquid may be achieved at a loading of 1-18 grams of the product per liter of the liquid; or a selenium removal efficiency of 95-100% in the liquid may be achieved at a loading of 8-20 grams of the product per liter of the liquid.

The method further comprises separating the liquid from the product to recover a resultant liquid that has a lower amount of arsenic and/or selenium than the liquid had prior to the contacting. For example, the resultant liquid may be recovered from the slurry by filtration or any other appropriate method known to those of skill in the art.

Other adsorption methods may be utilized. Such other adsorption methods may include passing arsenic and/or selenium containing liquids through columns packed with the surface functionalized clay disclosed herein. The contact time may be adjusted by varying process parameters such as column length, column diameter, adsorbent packing density, and/or liquid flow rate, etc.

### Description of Test Methods

### Surface Area, Pore Volume, Pore Size Distribution, Porosity

Surface area was measured by the nitrogen adsorption method of the BET (Brunauer-Emmett-Teller) method. Pore volume and pore size distribution of a sample of material was determined by mercury porosimetry. The mercury porosimetry uses mercury as an intrusion fluid to measure pore volume of a (weighed) sample of material enclosed inside a sample chamber of a penetrometer. The sample chamber is evacuated to remove air from the pores of the sample. The sample chamber and penetrometer are filled with mercury. Since mercury does not wet the material surface, it must be forced into the pores by means of external pressure. Progressively higher pressure is applied to allow mercury to enter the pores. The required equilibrated pressure is inversely proportional to the size of the pores, only slight pressure is required to intrude the mercury into macropores, whereas much greater external pressure is required to force mercury into small pores. The penetrometer reads the volume of mercury intruded and the intrusion data is used to calculate pore size distribution, porosity, average pore size and total pore volume. A Micromeritics AutoPore IV 9500 was used to analyze the samples herein.

Assuming pores of cylindrical shape, a surface distribution may be derived from the pore volume distribution for use in calculations. An estimate of the total surface area of the sample of material may be made from the pressure/volume curve (Rootare, 1967) without using a pore model as

$$A = \frac{1}{γ cos θ} {\int }_{{V}_{Hg , 0}}^{{V}_{Hg , max}} pdV$$

Where, A=total surface area
   γ=surface tension of the mercury
   θ=angle of contact of mercury with the material pore wall
   p=external applied pressure
   V=pore volume
      From the function V=V (p) the integral may be calculated by means of a numerical method.

From the pressure versus the mercury intrusion data, the instrument generates volume and size distribution of pores following the Washburn equation (Washburn, 1921) as:

$${d}_{i} = \frac{4 γ cos θ}{{P}_{i}}$$

Where, dᵢ=diameter of pore at an equilibrated external pressure
   Y=surface tension of the mercury
   θ=angle of contact of mercury with the material pore wall
   Pᵢ=external applied pressure

The average pore diameter is determined from cumulative intrusion volume and total surface area of the sample of material as:

$$D = \frac{4 V}{S}$$

Where, D=average pore diameter
V=total intrusion volume of mercury
S=total surface area

Porosity is the fraction of the total material volume that is taken up by the pore space. Porosity was calculated from mercury intrusion data.

### EXAMPLES

The products of Examples 1-5 each comprise clay. The products of Examples 1-5 were prepared from the different clay feed materials listed in Table 1.

TABLE 1
Feed Materials.

| | | | | | | | Median |
|---|---|---|---|---|---|---|---|
| | | | | | Surface | Pore | Pore |
| | | d 10 | d 50 | d 90 | Area | Volume | Diameter |
| | Feed Material | (μm) | (μm) | (μm) | (m²/g) | (mL/g) | (μm) |
| Feed | natural | 5.62 | 16.0 | 61.7 | 108 | 1.1935 | 3.26 |
| Material A | attapulgite | | | | | | |
| Feed | Min-U-Gel ® | 5.32 | 14.2 | 41.0 | 134 | 1.4806 | 1.87 |
| Material B | 400 | | | | | | |
| Feed | Natural sepiolite | 4.92 | 9.79 | 19.8 | 277 | 3.4586 | 2.72 |
| Material C | | | | | | | |

Feed material A was prepared using as feed material natural attapulgite mined near Climax, Georgia by Active Minerals International, LLC. The major elemental composition of this feed material, as determined by wave-length dispersive XRF analysis, is shown in Table 2.

TABLE 2
Major Oxide Composition of natural attapulgite material used
as feed material A(Ignited Basis).
Total Chemistry as determined by XRF (expressed as oxides)¹

| | |
|---|---|
| SiO₂ (wt. %) | 66.2 |
| Al₂O₃ (wt. %) | 12.1 |
| Fe₂O₃ (wt. %) | 4.2 |
| CaO (wt. %) | 2.8 |
| MgO (wt. %) | 9.9 |
| K₂O (wt. %) | 1.1 |
| CO₂ (wt. %) | 1.8 |
| TiO₂ (wt. %) | 0.6 |
| P₂O₅ (wt. %) | 1.0 |
| SO₄ (wt. %) | 0.2 |
| Other | 0.1 |

¹ Although the elements are reported as oxides, they are actually present as complex aluminosilicates.

Feed Material B was prepared using the commercially available Min-U-Gel 400® (Active Minerals International, LLC) as feed material. The Min-U-Gel 400 product is a non-purified natural attapulgite that has been air classified. The major elemental compositions of Min-U-Gel 400, as determined by wave-length dispersive x-ray fluorescence (XRF) analysis, is shown in Table 3. Feed material B contained about 13 wt. %-about 14 wt. % free moisture at 104° C.).

TABLE 3
Major Oxide Composition of air classified natural attapulgite
Min-U-Gel 400 used as feed material B (Ignited Basis).
Total Chemistry for Min-U-Gel 400 as determined by XRF
(expressed as oxides) ¹

| | |
|---|---|
| SiO₂ (wt. %) | 66.2 |
| Al₂O₃ (wt. %) | 12.1 |
| Fe₂O₃ (wt. %) | 4.2 |
| CaO (wt. %) | 2.8 |
| MgO (wt. %) | 9.9 |
| Na₂O (wt. %) | |
| K₂O (wt. %) | 1.1 |
| TiO₂ (wt. %) | 0.6 |
| P₂O₅ (wt. %) | 1.0 |
| Free Moisture, wt. % @ 220° F. (104° C.) | 13.5 |
| Residue (wet) % retained on 325 mesh | 0.005 |
| screen | |

¹ Although the elements are reported as oxides, they are actually present as complex aluminosilicates.

Feed Material C was prepared using natural sepiolite obtained from Sigma-Aldrich. The natural sepiolite contained about 13 wt. % magnesium (Mg). Feed material C had a high surface area of about 272 m²/g, as measured by the nitrogen adsorption method based on the Brunauer-Emmett-Teller (BET) theory. Particle size (d₅₀) of this feed material, as measured by a laser particle size analyzer, was about 14.2 microns. Feed material C contained about 9.7 wt. % moisture (as determined by loss on drying). The Certificate of Analysis (COA) of the sepiolite is shown in Table 4.

TABLE 4
Certificate of analysis (COA) of natural sepiolite used as feed material C.
Certificate of analysis for natural sepiolite

| | |
|---|---|
| Mg (wt. %) as determined by Atomic | 13 |
| Absorption | |
| Loss on drying (moisture content) wt. % | 9.7 |
| Loss on ignition wt. % | 17.7 |

The feed materials A-C have a high surface area from about 100 to 280 m²/g, as measured by the nitrogen adsorption method based on the Brunauer-Emmett-Teller (BET) theory. Particle size (d₅₀) of these feed materials, as measured by a laser particle size analyzer, is about 9-about 16 microns.

The median pore diameter of the Feed Materials A-C (as measured by mercury intrusion) was about 1.8 microns to about 3.3 microns. In addition, Feed Materials A-C had a pore volume of about 1.1935 mL/g to about 3.4586 mL/g. The high surface area and unique porous structure of the products comprising surface functionalized attapulgite and/or sepiolite make these products effective adsorbents for various applications including arsenic and/or selenium adsorption.

### Example 1

A surface treating solution of iron chloride was prepared by mixing 20 grams of iron chloride (FeCl₃) (MilliporeSigma) with 20 g of DI water in a beaker with a magnetic stir bar for 10 minutes. 80 g of Feed Material A was placed in a coffee grinder and iron chloride solution was injected slowly around the attapulgite using 1 mL syringe. After mixing for 30 seconds in the coffee grinder, the coffee grinder sides were scrapped with a spatula. More iron chloride solution was mixed with the attapulgite using the same procedure until all of the iron chloride solution was added. To neutralize pH of the mixture of clay and surface treating solution, 29.89 g of 50% concentrated NaOH solution was then added and mixed in the coffee grinder using the same procedure as adding iron chloride solution. The mixture was dried in the oven at 100° C. for 2 hours followed by 200° C. for 30 minutes.

### Example 2

A surface treating solution of iron chloride was prepared by mixing 20 grams of iron chloride (FeCl₃) (MilliporeSigma) with 20 g of DI water in a beaker with a magnetic stir bar for 10 minutes. 80 g of Feed material A was placed in a Ninja food processor and the iron chloride surface treating solution was injected slowly around the attapulgite using 1 mL syringe. After mixing for a few seconds in the Ninja food processor, the Ninja food processor sides were scrapped with a spatula. More iron chloride surface treating solution was added to and mixed with the attapulgite using the same procedure until all of the iron chloride solution was added and well dispersed. To neutralize the pH of the above mixture, 29.89 g of 50% concentrated NaOH solution was then added and mixed in the coffee grinder using the same procedure as adding iron chloride solution. An additional 30 mL of DI water was then slowly added until the mixture became granular. The granules were dried in the oven at 100° C. for 2 hours followed by 200° C. for 30 minutes.

### Example 3

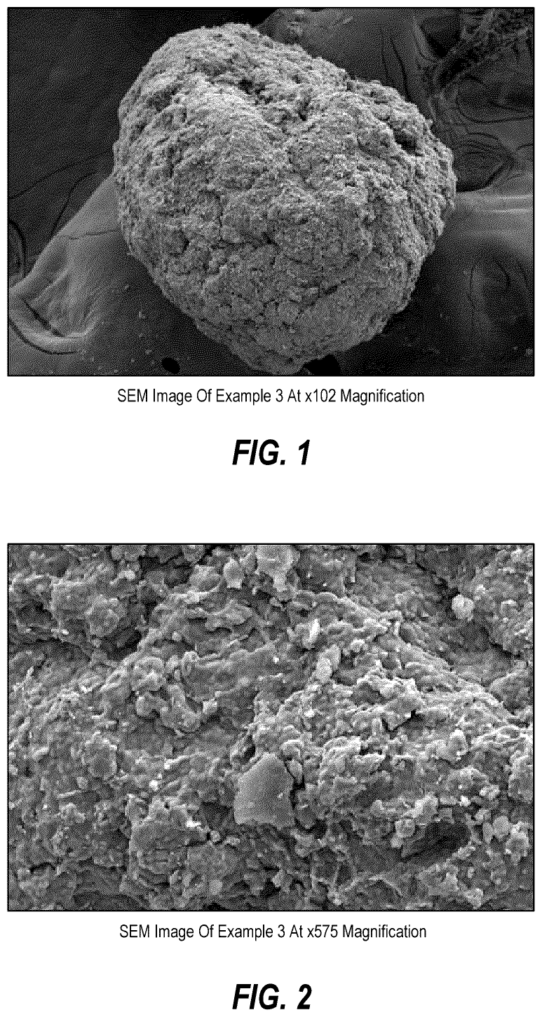

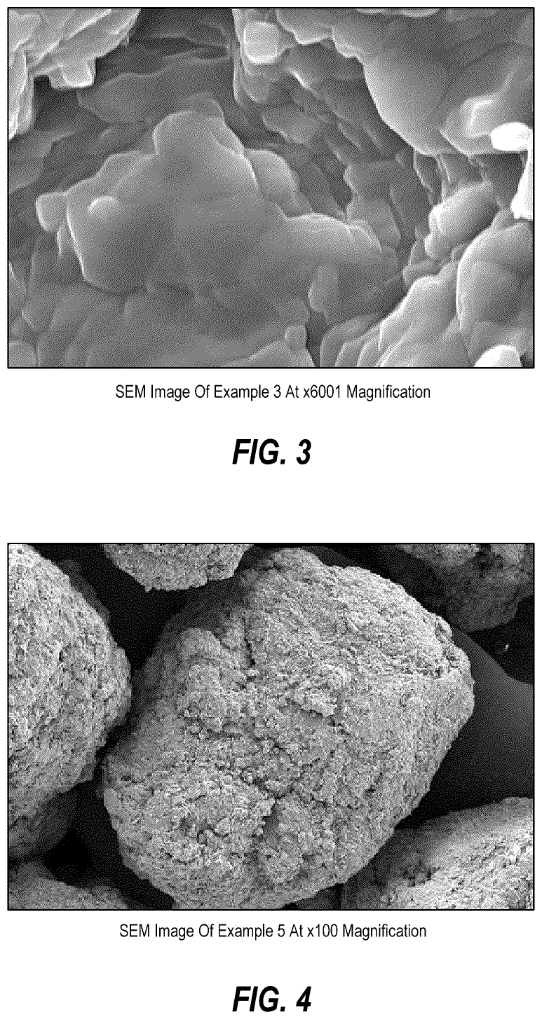

A silica binder solution was prepared by mixing 2.56 g of LUDOX® AM colloidal silica (MilliporeSigma) with 10 g of DI water in a beaker with a magnetic stir bar for 10 minutes at 600 rpm. A surface treating solution was prepared by mixing 25 grams of iron chloride (FeCl₃, Sigma-Aldrich) with 25 g of DI water in a beaker with a magnetic stir bar for 10 minutes. 100 g of Feed material A was placed in a Ninja food processor and then the silica binder solution was poured over the attapulgite. After mixing for 10 seconds, the Ninja food processor sides were scrapped with a spatula. The mixing and scraping procedure repeated for 2 additional times. The iron chloride solution was then poured over the mixture. After mixing for 10 seconds, the Ninja food processor sides were scrapped with a spatula. The mixing and scraping procedure repeated for 2 additional times. 37.36 g of NaOH (50% concentration) (Lab Alley) was mixed with 15 g of DI water in a beaker with a magnetic stir bar for 10 minutes at 600 RPM. The NaOH solution was then poured into the Ninja food processor contained the mixture of attapulgite mixed with iron chloride and NaOH. After mixing for 10 seconds, the Ninja food processor sides were scrapped with a spatula. The mixing and scraping procedure repeated for 2 additional times to form granules. The granules were dried in the oven at 100° C. for 2 hours followed by 200° C. for 30 minutes. FIG. 1 is a SEM image of Example 3 at a magnification of ×102. FIG. 2 is a SEM image of Example 3 at a magnification of ×575 that shows an enlarged view of the surface of the granule seen in FIG. 1. FIG. 3 is a SEM image of Example 3 at a magnification of ×6001 that shows an even more enlarged view of the surface of the granule seen in FIG. 1.

### Example 4

The process to make Example 3 was repeated except Feed Material B, instead of Feed material A, was used.

### Example 5

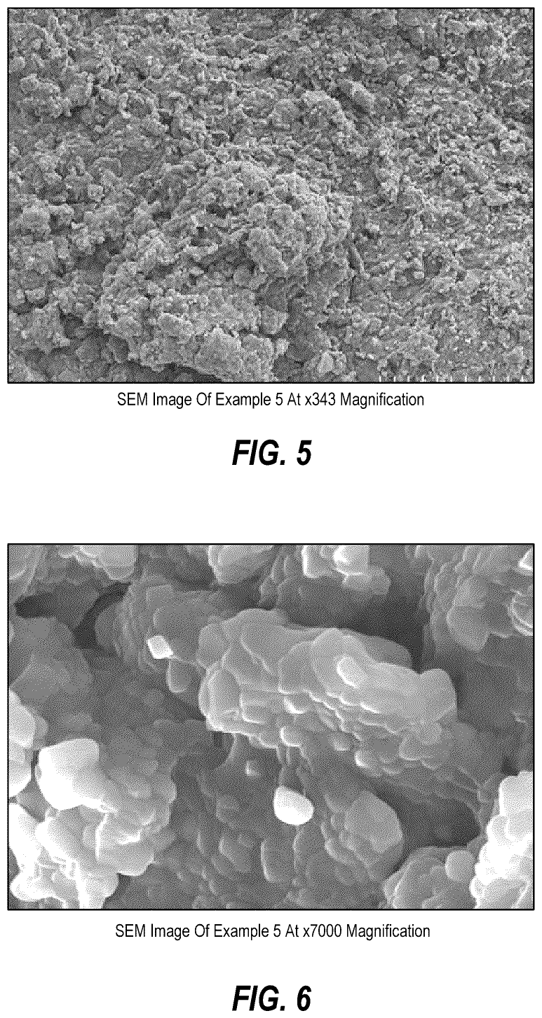

The process to make Example 3 was repeated except natural Feed Material C, instead of Feed material A, was used. FIG. 4 is a SEM image of Example 5 at a magnification of ×100. FIG. 5 is a SEM image of Example 5 at a magnification of ×343 that illustrates an enlarged view of the surface of the granule of FIG. 4. FIG. 6 is a SEM image of Example 5 at a magnification of ×7000 illustrating an even more enlarged view of the surface of the granule of FIG. 4.

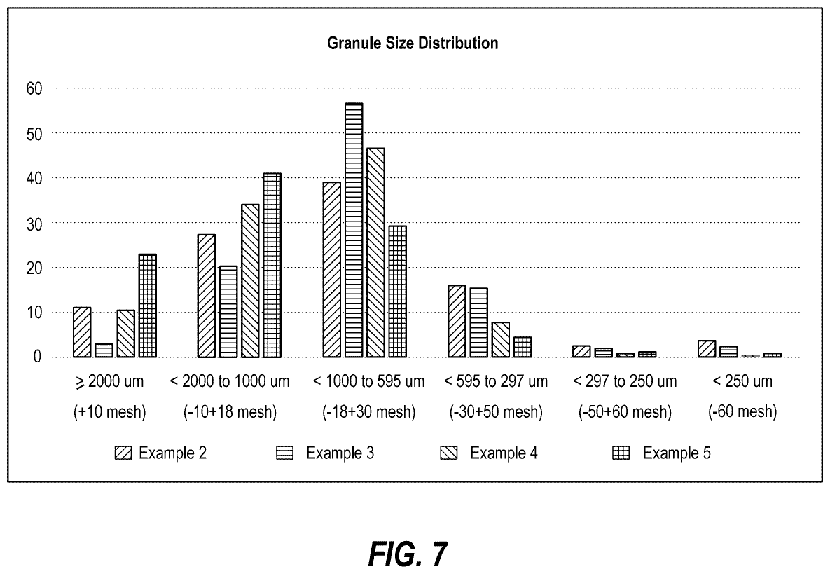

Granule size distribution for Examples 1-5 was measured using sieve analysis. To do so, 100 g of granule sample was place on top of a sieve stack of 10 mesh (2000 micrometer(s) (μ) (also referred to as micron(s) (μm))), 18 mesh (1000 μm), 30 mesh (595 μm), 50 mesh (297 μm) and 60 mesh (250 μm). The sieve stack was tapped about 1 minute and the granules on top of each sieve was weighted to calculate granule size distribution. Table 2 below shows the granule size distribution by sieve analysis. FIG. 7 illustrates the granule size distribution in a bar chart. FIG. 7 illustrates granules that are +10 mesh (granules sized greater than or equal to 2000 microns); granules that are −10+18 mesh (granules that are sized less than 2000 microns to greater than or equal to 1000 microns); granules that are −18+30 mesh (granules that are sized less than 1000 microns to greater than or equal to 595 microns); granules that are −30+50 mesh (granules that are sized less than 595 microns to greater than or equal to 297 microns); granules that are −50+60 mesh (granules/particles that are less than 297 microns to greater than or equal to 250 microns); and granules/particles that are −60 mesh (sized less than 250 microns).

As can be seen in Table 2 below, for Example 3: 3% was retained on the 10 mesh sieve (or 3% of Example 3 was granules larger than or equal to 2000 microns); 20.5% of Example 3 passed through the 10 mesh sieve and was retained on the 18 mesh sieve (or 20.5% of the material was granules sized less than 2000 microns to greater than or equal to 1000 microns); 56.5% passed through the 18 mesh sieve and was retained on the 30 mesh sieve (or 56.5% of Example 3 was granules sized less than 1000 microns to greater than or equal to 595 microns); 15.4% passed through the 30 mesh sieve and were retained on the 50 mesh size sieve (or 15.4% of Example 3 was granules less than 595 microns to greater than or equal to 297 microns); 2.0% passed through the 50 mesh sieve and were retained on the 60 mesh sieve (or 2.0% of the granules/particles were sized less than 297 microns to greater than or equal to 250 microns); and 2.5% of the granules/particles passed through the 60 mesh sieve (or were sized less than 250 microns or smaller).

TABLE 2
Granule size distribution by sieve analysis (%).

| | Exam- | Exam- | Exam- | Exam- | Exam- |
|---|---|---|---|---|---|
| Granule size | ple 1 | ple 2 | ple 3 | ple 4 | ple 5 |
| range | (%) | (%) | (%) | (%) | (%) |
| retained on 10 | 0.19 | 11.0 | 3.0 | 10.3 | 23.2 |
| mesh sieve; | | | | | |
| (granules | | | | | |
| sized ≥2000 μm) | | | | | |
| passed through 10 | 0.16 | 27.7 | 20.5 | 34.3 | 40.9 |
| mesh sieve and | | | | | |
| retained on 18 | | | | | |
| mesh sieve; | | | | | |
| (granules | | | | | |
| sized <2000 μm | | | | | |
| to ≥1000 μm) | | | | | |
| Passed through 18 | 1.23 | 39.1 | 56.5 | 46.6 | 29.6 |
| mesh and retained | | | | | |
| on 30 mesh; | | | | | |
| (granules | | | | | |
| sized <1000 μm | | | | | |
| to ≥595 μm) | | | | | |
| Passed through 30 | 20.44 | 15.9 | 15.4 | 7.8 | 4.5 |
| mesh and retained | | | | | |
| on 50 mesh; | | | | | |
| (granules | | | | | |
| sized <595 μm | | | | | |
| to ≥297 μm) | | | | | |
| Passed through 50 | 12.0 | 2.7 | 2.0 | 0.65 | 1.1 |
| mesh and retained | | | | | |
| on 60 mesh; | | | | | |
| (granules/ | | | | | |
| particles | | | | | |
| sized <297 μm | | | | | |
| to ≥250 μm) | | | | | |
| Passed through 60 | 65.98 | 3.7 | 2.5 | 0.45 | 0.7 |
| mesh | | | | | |
| (granules/ | | | | | |
| particles | | | | | |
| sized <250 μm) | | | | | |

### Example 6

Influent arsenic and selenium solutions were prepared by spiking 1000 parts per million (ppm) arsenic and selenium standard solution into deionized (DI) water to make arsenic and selenium concentrations around 10 ppm. Arsenic and selenium concentrations were measured using Inductively Coupled Plasma (ICP) before and after the adsorption reaction.

For the arsenic and selenium adsorption test, 0.25 g to 4 g of adsorbent was mixed with 250 mL of the prepared arsenic and selenium solution in a 500 mL glass flask for 3 minutes to 30 minutes on a magnetic stirrer plate at room temperature. The mixture solution was filtered through a disposable 250 mL filter with 4-7-micron pore size filter paper (Whatman 597 filter). The filtered solution was collected for ICP analysis.

Arsenic and selenium removal efficiency was calculated as follows (where “conc” is shorthand for “concentration”):

$$Removal efficiency = \frac{( Influent As or Se conc - Residual As or Se conc ) \times 100}{Influent As or Se concentration}$$

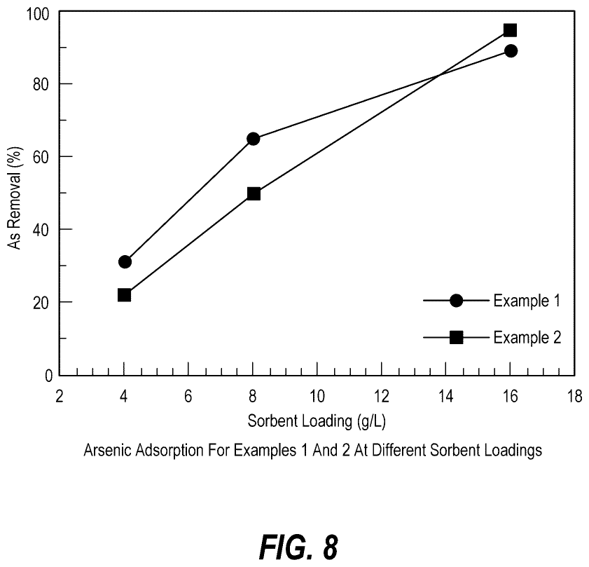

The results of the Arsenic adsorption test for Examples 1 and 2 are shown in Table 3. FIG. 8 illustrates Arsenic adsorption for Examples 1 and 2 at different sorbent loadings.

TABLE 3
Arsenic adsorption for Examples 1 and 2.

| | Adsorbent | Contact | | | As Removal |
|---|---|---|---|---|---|
| | Loading | Time | Influent | Residual | efficiency |
| Adsorbent | (g/L) | (min) | As (ppm) | As (ppm) | (%) |
| Feed | 1 | 3 | 9.20 | 9.52 | |
| Material A | | | | | |
| Example 1 | 4 | 3 | 9.23 | 6.41 | 30.6 |
| Example 1 | 8 | 3 | 11.1 | 3.90 | 64.9 |
| Example 1 | 16 | 3 | 9.23 | 1.02 | 88.9 |
| Example 2 | 4 | 3 | 9.23 | 7.22 | 21.8 |
| Example 2 | 8 | 3 | 11.1 | 5.52 | 50.3 |
| Example 2 | 16 | 3 | 9.23 | 0.425 | 95.4 |

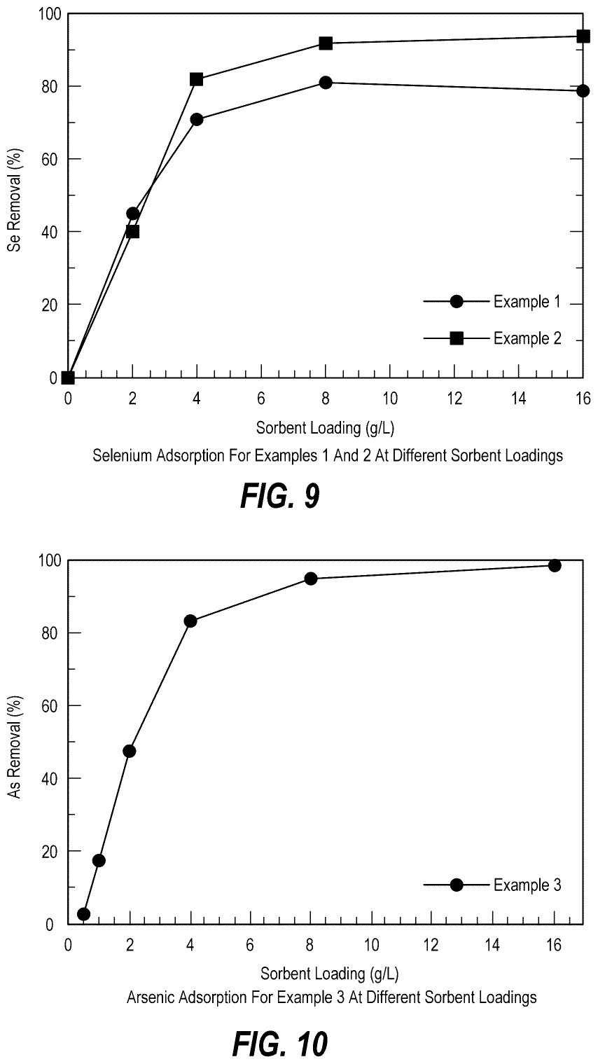

Table 4 shows the Selenium adsorption for Examples 1 and 2. FIG. 9 illustrates Selenium adsorption for Examples 1 and 2 at different sorbent loadings.

TABLE 4
Selenium adsorption for Examples 1 and 2.

| | Adsorbent | Contact | | | Se Removal |
|---|---|---|---|---|---|
| | Loading | Time | Influent | Residual | efficiency |
| Adsorbent | (g/L) | (min) | Se (ppm) | Se (ppm) | (%) |
| Feed | 1 | 3 | 10.4 | 10.2 | 1.9 |
| Material A | | | | | |
| Example 1 | 2 | 3 | 9.67 | 5.31 | 45.1 |
| Example 1 | 4 | 3 | 9.67 | 6.41 | 33.7 |
| Example 1 | 8 | 3 | 9.67 | 2.81 | 70.9 |
| Example 1 | 16 | 3 | 10.20 | 2.12 | 79.2 |
| Example 2 | 2 | 3 | 16.6 | 10.0 | 39.8 |
| Example 2 | 4 | 3 | 16.6 | 3.1 | 81.6 |
| Example 2 | 8 | 3 | 16.6 | 1.4 | 91.6 |
| Example 2 | 16 | 3 | 9.67 | 0.588 | 93.9 |

Table 5 illustrates the Arsenic adsorption for Examples 3, 4 and 5. FIG. 10 illustrates Arsenic adsorption for Examples 3 at different sorbent loadings.

TABLE 5
Arsenic adsorption for Examples 3, 4 and 5.

| | Adsorbent | Contact | | | As Removal |
|---|---|---|---|---|---|
| | Loading | Time | Influent | Residual | efficiency |
| Adsorbent | (g/L) | (min) | As (ppm) | As (ppm) | (%) |
| Example 3 | 0.5 | 30 | 9.31 | 9.07 | 2.6 |
| Example 3 | 1 | 30 | 9.31 | 7.68 | 17.5 |
| Example 3 | 2 | 30 | 9.31 | 4.88 | 47.6 |
| Example 3 | 4 | 30 | 9.31 | 1.56 | 83.2 |
| Example 3 | 8 | 30 | 9.31 | 0.47 | 95.0 |
| Example 3 | 16 | 30 | 9.31 | 0.11 | 98.8 |
| Example 4 | 4 | 30 | 9.31 | 3.03 | 67.5 |
| Example 4 | 8 | 30 | 9.31 | 0.76 | 91.8 |
| Example 4 | 16 | 30 | 9.31 | 0.22 | 97.7 |
| Example 5 | 4 | 30 | 9.31 | 3.28 | 64.8 |
| Example 5 | 8 | 30 | 9.31 | 0.56 | 94.0 |
| Example 5 | 16 | 30 | 9.31 | 0.204 | 97.8 |

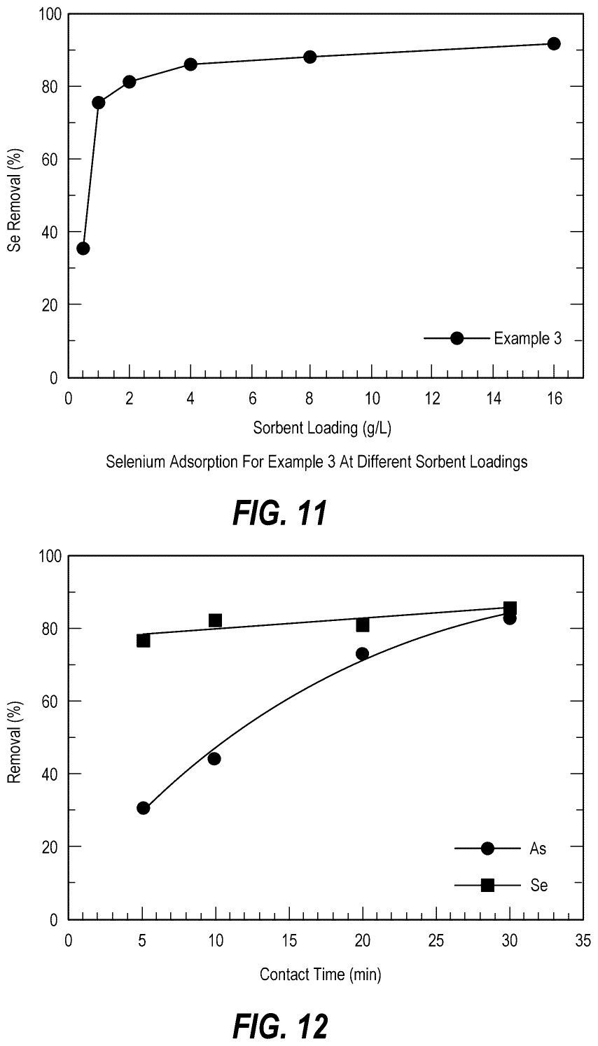

Table 6 illustrates Selenium adsorption for Examples 3, 4 and 5. FIG. 11 illustrates Selenium adsorption for Examples 3 at different sorbent loadings.

TABLE 6
Selenium adsorption for Examples 3, 4 and 5.

| | Adsorbent | Contact | | | Se Removal |
|---|---|---|---|---|---|
| | Loading | Time | Influent | Residual | efficiency |
| Adsorbent | (g/L) | (min) | Se (ppm) | Se (ppm) | (%) |
| Example 3 | 0.5 | 30 | 10.7 | 6.9 | 35.5 |
| Example 3 | 1 | 30 | 10.7 | 2.61 | 75.6 |
| Example 3 | 2 | 30 | 9.85 | 1.83 | 81.4 |
| Example 3 | 4 | 30 | 9.85 | 1.36 | 86.2 |
| Example 3 | 8 | 30 | 9.85 | 1.16 | 88.2 |
| Example 3 | 16 | 30 | 9.85 | 0.82 | 91.7 |
| Example 4 | 2 | 30 | 9.85 | 1.15 | 88.3 |
| Example 4 | 4 | 30 | 9.85 | 2.15 | 78.2 |
| Example 4 | 8 | 30 | 9.85 | 1.61 | 83.7 |
| Example 4 | 16 | 30 | 9.85 | 1.36 | 86.2 |
| Example 5 | 2 | 30 | 9.85 | 0.25 | 97.4 |
| Example 5 | 4 | 30 | 9.85 | 0.06 | 99.4 |
| Example 5 | 8 | 30 | 9.85 | 0.03 | 99.7 |
| Example 5 | 16 | 30 | 9.85 | 0.071 | 99.3 |

Tables 7 & 8 and FIG. 12 illustrates the impact of contact time on arsenic and selenium adsorption for Example 3.

TABLE 7
Arsenic adsorption at different contact times for Example 3.

| Adsorbent | Contact | | | As Removal |
|---|---|---|---|---|
| Loading | Time | Influent | Residual | efficiency |
| (g/L) | (min) | As (ppm) | As (ppm) | (%) |
| 4 | 5 | 8.41 | 5.81 | 30.9 |
| 4 | 10 | 8.41 | 4.69 | 44.2 |
| 4 | 20 | 8.41 | 2.28 | 72.9 |
| 4 | 30 | 9.31 | 1.56 | 83.2 |

TABLE 8
Selenium adsorption at different contact times for Example 3.

| Adsorbent | Contact | | | Se Removal |
|---|---|---|---|---|
| Loading | Time | Influent | Residual | efficiency |
| (g/L) | (min) | Se (ppm) | Se (ppm) | (%) |
| 4 | 5 | 9.22 | 2.12 | 77.0 |
| 4 | 10 | 9.22 | 1.60 | 82.6 |
| 4 | 20 | 9.22 | 1.72 | 81.3 |
| 4 | 30 | 9.85 | 1.36 | 86.2 |

### INDUSTRIAL APPLICABILITY

In general, the foregoing disclosure finds utility in the removal of arsenic and selenium contained in liquids. Historically, common commercially available heavy metal removal technologies include activated carbon adsorption, surface modified activated carbon adsorption, separation by microemulsion liquid membranes, ion exchange and. The slow kinetics, poor selectivity for arsenic and selenium and low loading capacity of these technologies make the arsenic and selenium removal process ineffective and expensive.

The novel product disclosed herein can be used as an adsorbent for reducing arsenic and/or selenium in liquids. Such product have high removal efficiency for arsenic and selenium, which significantly reduces process time and provides greater removal of arsenic and/or selenium from liquids. Furthermore, compared to the commercially utilized activated carbon, the products disclosed herein may be used in significantly smaller quantities, which create less waste product to be disposed.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A product for adsorbing a heavy metal in a liquid, the product comprising clay that has been surface functionalized with a surface treating agent, the surface treating agent including (a) one or more arsenic affinity functional groups, and/or (b) one or more selenium affinity functional groups,
wherein the weight percentage of components of the product includes:
70-99 wt. % clay and
1-30 wt. % surface treating agent that includes the one or more arsenic affinity functional groups and/or the one or more selenium affinity functional groups,
wherein 60-95% of the product is in the form of granules sized to pass through a 10 mesh sieve and to be retained on a 60 mesh sieve, or sized in the range of less than 2000 microns to 250 microns,
wherein the clay includes attapulgite and/or sepiolite,
wherein, the arsenic affinity functional groups are deposited on the clay surface and/or the selenium affinity functional groups are deposited on the clay surface,
wherein the heavy metal includes arsenic and/or selenium.

2. The product of claim 1,
wherein 45-65% of the product is in the form of granules sized to pass through a 18 mesh sieve and to be retained on a 30 mesh sieve, or granules sized in a range of less than 1000 microns to 595 microns,
wherein 15-25% of the product is in the form of granules sized to pass through the 10 mesh sieve and to be retained on the 18 mesh sieve, or granules sized in the range of less than 2000 microns to 1000 microns.

3. The product of claim 1, wherein less than 5% of the product is in the form of granules and/or particles sized to pass through the 60 mesh sieve, or sized less than 250 microns.

4. The product of claim 1, wherein: the product has an arsenic removal efficiency of 60-100% in the liquid, at a loading of 4-18 grams of the product per liter of the liquid; or the product has the arsenic removal efficiency of 90-100% in the liquid, at a loading of 6-18 grams of the product per liter of the liquid; or the product has the arsenic removal efficiency of 95-100% in the liquid, at a loading of 6-18 grams of the product per liter of the liquid; or the product has the arsenic removal efficiency of 97-100%, at a loading of 6-18 grams of the product per liter of the liquid.

5. The product of claim 1, wherein: the product has a selenium removal efficiency of 60-100%, at a loading of 1-18 grams of the product per liter of the liquid; or the product has the selenium removal efficiency of 80-100% in the liquid, at a loading of 1-18 grams of the product per liter of the liquid; or the product has the selenium removal efficiency of 90-100%, at a loading of 1-18 grams of the product per liter of the liquid; or the product has the selenium removal efficiency of 95-100% in the liquid, at a loading of 8-20 grams of the product per liter of the liquid.

6. The product of claim 1,
wherein 35-55% of the product is in the form of granules sized to pass through a 18 mesh sieve and to be retained on a 30 mesh sieve, or granules sized in a range of less than 1000 microns to 595 microns,
wherein 25-45% of the product is in the form of granules sized to pass through the 10 mesh sieve and to be retained on the 18 mesh sieve, or granules sized in a range of less than 2000 microns to 1000 microns.

7. The product of claim 1, wherein the liquid includes water, oil, liquified natural gas, wastewater, or combinations thereof.

8. The product of claim 1,
wherein 25-35% of the product is in the form of granules sized to pass through the 18 mesh sieve and to be retained on a 30 mesh sieve, or granules sized in a range of less than 1000 microns to 595 microns,
wherein 30-50% of the product is in the form of granules sized to pass through the 10 mesh sieve and to be retained on a 18 mesh sieve, or granules sized in a range of less than 2000 microns to 1000 microns.

9. A method of producing a product for adsorbing a heavy metal from a liquid, the method comprising:
surface functionalizing clay with a solution, the solution including a surface treating agent that includes (a) one or more arsenic affinity functional groups, and/or (b) one or more selenium affinity functional groups,
wherein the weight percentage of components of the product includes:
70-99 wt. % clay; and
1-30 wt. % surface treating agent that includes the one or more arsenic affinity functional groups, and/or the one or more selenium affinity functional groups,
wherein 60-95% of the product is in the form of granules sized to pass through a 10 mesh sieve and to be retained on a 60 mesh sieve, or sized in the range of less than 2000 microns to 250 microns,
wherein the clay includes attapulgite and/or sepiolite,
wherein, the arsenic affinity functional groups are deposited on the clay surface and/or the selenium affinity functional groups are deposited on the clay surface,
wherein the heavy metal includes arsenic and/or selenium.

10. The method of claim 9, wherein the surface treating agent comprises iron chloride, titanium oxide, activated alumina, zirconium oxide, iron oxide, Fe (III) loaded resins, iron oxide, metal oxides, agricultural biomasses, goethite, zerovalent iron, mesoporous alumina, or a metal-based nanocomposite.

11. The method of claim 9 further comprising mixing a binder solution with the clay.

12. The method of claim 11, further comprising neutralizing the pH of the surface functionalized clay with sodium hydroxide.

13. The method of claim 12, wherein:
wherein 45-65% of the product is in the form of granules sized to pass through a 18 mesh sieve and to be retained on a 30 mesh sieve, or granules sized in a range of less than 1000 microns to 595 microns, wherein 15-25% of the product is in the form of granules sized to pass through the 10 mesh sieve and to be retained on the 18 mesh sieve, or granules sized in the range of less than 2000 microns to 1000 microns; or
wherein 35-55% of the product is in the form of granules sized to pass through the 18 mesh sieve and to be retained on the 30 mesh sieve, or granules sized in a range of less than 1000 microns to 595 microns, wherein 25-45% of the product is in the form of granules sized to pass through the 10 mesh sieve and to be retained on the 18 mesh sieve, or granules sized in a range of less than 2000 microns to 1000 microns; or
wherein 25-35% of the product is in the form of granules sized to pass through the 18 mesh sieve and to be retained on the 30 mesh sieve, or granules sized in a range of less than 1000 microns to 595 microns, wherein 30-50% of the product is in the form of granules sized to pass through the 10 mesh sieve and to be retained on the 18 mesh sieve, or granules sized in a range of less than 2000 microns to 1000 microns.

14. The method of claim 9 further comprising drying the clay after the surface treating, wherein the surface treating solution is dried on the clay of the product produced.

15. The method of claim 9, wherein: the product has an arsenic removal efficiency of 60-100% in the liquid, at a loading of 4-18 grams of the product per liter of the liquid; or the product has the arsenic removal efficiency of 90-100% in the liquid, at a loading of 6-18 grams of the product per liter of the liquid; or the product has the arsenic removal efficiency of 95-100% in the liquid, at a loading of 6-18 grams of the product per liter of the liquid; or the product has the arsenic removal efficiency of 97-100%, at a loading of 6-18 grams of the product per liter of the liquid.

16. The method of claim 9, wherein: the product has a selenium removal efficiency of 60-100%, at a loading of 1-18 grams of the product per liter of the liquid; or the product has the selenium removal efficiency of 80-100% in the liquid, at a loading of 1-18 grams of the product per liter of the liquid; or the product has the selenium removal efficiency of 90-100%, at a loading of 1-18 grams of the product per liter of the liquid; or the product has the selenium removal efficiency of 95-100% in the liquid, at a loading of 8-20 grams of the product per liter of the liquid.

17. A method for adsorbing at least one heavy metal in a liquid, the method comprising:
contacting the liquid with a product, the product comprising clay that has been surface functionalized with a surface treating agent that includes (a) one or more arsenic affinity functional groups, and/or (b) one or more selenium affinity functional groups; and
separating the liquid from the product to recover a resultant liquid that has a lower amount of arsenic and/or selenium than the liquid had prior to the contacting,
wherein the weight percentage of the components of the product includes: 70-99 wt. % clay, and 1-30 wt. % surface treating agent,
wherein 60-95% of the product is in the form of granules sized to pass through a 10 mesh sieve and to be retained on a 60 mesh sieve, or sized in the range of less than 2000 microns to 250 microns,
wherein the clay includes attapulgite and/or sepiolite,
wherein, the arsenic affinity functional groups are deposited on the clay surface and/or the selenium affinity functional groups are deposited on the clay surface,
wherein the product is loaded in the liquid at a weight percentage to have a removal efficiency for arsenic and/or selenium in the liquid of 60-100%.

18. The method of claim 17, the liquid includes water, oil, liquified natural gas, wastewater, or combinations thereof.

19. The method of claim 17, wherein:
wherein 45-65% of the product is in the form of granules sized to pass through a 18 mesh sieve and to be retained on a 30 mesh sieve, or granules sized in a range of less than 1000 microns to 595 microns, wherein 15-25% of the product is in the form of granules sized to pass through the 10 mesh sieve and to be retained on the 18 mesh sieve, or granules sized in the range of less than 2000 microns to 1000 microns; or
wherein 35-55% of the product is in the form of granules sized to pass through the 18 mesh sieve and to be retained on the 30 mesh sieve, or granules sized in a range of less than 1000 microns to 595 microns, wherein 25-45% of the product is in the form of granules sized to pass through the 10 mesh sieve and to be retained on the 18 mesh sieve, or granules sized in a range of less than 2000 microns to 1000 microns; or
wherein 25-35% of the product is in the form of granules sized to pass through the 18 mesh sieve and to be retained on the 30 mesh sieve, or granules sized in a range of less than 1000 microns to 595 microns, wherein 30-50% of the product is in the form of granules sized to pass through the 10 mesh sieve and to be retained on the 18 mesh sieve, or granules sized in a range of less than 2000 microns to 1000 microns.

20. The method of claim 17, wherein the product is loaded in the liquid at a weight percentage to have a removal efficiency for arsenic and/or selenium in the liquid of 90% to 100%, or 95% to 100%.
